(19) United States
(12) Patent Application Publication
(10) Pub. No.: US 2020/0137025 A1
(43) Pub. Date: Apr. 30, 2020

(54) METHOD AND SYSTEM IN PAIRING A UNIQUE ALPHANUMERIC NAME/S TO ANY CALLABLE NUMBER OR SIP ACCOUNT TO GENERATE UNIQUE AND EASY TO REMEMBER URL CALLING LINK FOR REAL TIME COMMUNICATION PURPOSES

(71) Applicant: Joel Z. SAPUL, Mandaluyong City (PH)

(72) Inventor: Joel Z. SAPUL, Mandaluyong City (PH)

(21) Appl. No.: 16/727,505

(22) Filed: Dec. 26, 2019

Related U.S. Application Data
(63) Continuation-in-part of application No. PCT/PH2017/000007, filed on Jul. 19, 2017.

(30) Foreign Application Priority Data
Jun. 27, 2017 (PH) 12017000187

(51) Int. Cl. H04L 29/12; H04L 29/08

(52) U.S. Cl. CPC H04L 61/3025; H04L 61/2007; H04L 65/608; H04L 67/306; H04L 67/20; H04L 67/02

(57) ABSTRACT

A system and method of enabling callers to generate and use unique alphanumeric name or names appended to a domain name or use as domain name itself, when paired to the destination device, to enable a calling device to communicate with a destination device over the internet without dialing the destination device common mobile number.

### CROSS REFERENCE TO RELATED APPLICATIONS

This application is a Continuation-in-Part of PCT International Application No. PCT/PH2017/000007, filed on Jul. 19, 2017, which claims priority under 35 U.S.C. 119(a) to patent application Ser. No. 12/017,000187, filed in the Philippines on Jun. 27, 2017, all of which are hereby expressly incorporated by reference into the present application.

### TECHNICAL DESCRIPTION

The invention relates in general about generating and pairing automatically a unique web link for making a call or sending a message to a legacy phone, legacy mobile devices or other communication devices, more specifically, it is a system and method of enabling callers (6) to generate and use unique alphanumeric name or names appended to a domain name or use as domain name itself (10), when paired to the destination device (4), to enable a calling device (20) to communicate with a destination device (4) over the internet without dialing the destination device common mobile number.

### BACKGROUND OF THE ART

Voluminous amount of information are available in the worldwide web, including contact details of various entities, may it be a company or a person.

Making calls to a phone number through a web browser is presently known. Further, as seen in the prior art (U.S. Pat. No. 6,594,254B1), users can translate a telephone number into a domain name. However, this only automatically generates the domain name into an IP address or URL into a syntax or format which is based on the actual contact number or telephone number of an entity (e.g., a domain name which contains the country code, area code, subscriber number).

With regard to D1 cited in WO/ISA (Form PCT/ISA/237), this system requires a user to create an account but without considering an alphanumeric replacement for the Callable Number for easy recollection. It does not also show how to connect such video calls to regular telephones. While usernames are taught to be used, the system further requires a chatroom before the users can communicate. It is the link to this chatroom which users can utilize to communicate with each other; but the link name is not directly associated with the Callable Number of the device sought to be called.

With D2, D3, D4 and D5, these teach connecting a WebRTC to an established VoIP. However, these do not teach the use a custom alphanumeric names from the destination device to select to replace a Callable Number to easily remember the latter.

The problem is that the user cannot input his desired and unique code, such as an alphanumeric reference, to be associated with a set of contact details. Further, the user is limited to using a part of the telephone number as a code. This makes it difficult for a user to access and retrieve existing data as it still requires the user to know and remember, at least, a part of the telephone number he needs to call, which may refer to many telephone numbers. The present technology provides a more time-efficient, easy to remember and user-friendly system to register, store, and call any contact information to make web-based communications, or other forms of communication.

The present invention allows the user to create a personalized, yet unique, alphanumeric combination (e.g., a name of a person, a generic word) associated with a telephone number or identity of the destination party. From this unique alphanumeric combination, the present system will also generate a unique URL in a domain which the user may access in the future, and which he may share to third parties who may have similar access to the same contact information.

This unique alphanumeric URL makes it easier for users to remember the web link to call the destination party, instead of memorizing a series of telephone numbers to input into the browser, or tediously going through a database of records containing multiple entries which may or may not contain similar names, numbers, and entries.

The present system also provides a more simplified generation of callable web link, as it may be done through any device which has access to, or connected to, a network or the internet.

This system allows the URL or web link to be shared to third parties, which may be used for personal matters, e.g., a family sharing an alpha-numeric link and generated by the system based on the name of the family's pet dog. This system may also be used commercially, e.g., a company using such alphanumeric link based on the company's name to enable customers to access its business phones by using direct computer browser to call and make business easier using easy to remember link associated to the company name or company services. (e.g. www.hotel.com/vista resort. Where the appended name “vistaresort” or subdirectory in this manner used, is unique to the business establishment and the domain name “hotel.com” is shared domain for the service provider”

### BRIEF DESCRIPTION OF THE DRAWINGS

FIG. 1 shows the main components of the system as well as the network connections.

FIG. 2 shows the method of pairing the alphanumeric name (10) with the destination device (4).

FIG. 3 shows how communication can be made through the system.

FIG. 4 shows an example of a user interface for pairing and calling an alphanumeric name (10) with a destination device (4).

### DETAILED DESCRIPTION

The present invention relates to a method and system of generating, pairing and using an alphanumeric name (10) with the destination device (4) to enable the calling device (20) to call said destination device (4). The destination device (4) is any callable telephone, mobile number or SIP account. The communication may be through a voice call, video call, text or graphic message, and any other form of known multi media communication. Hence, a call as used in this description and the claims may refer to any form of known communication, as appropriate.

From the alphanumeric name (10), the system uses a domain name and a subdirectory associated with the alphanumeric name forming the URL (10), that points to the contact destination device (4). Thereafter, a caller (6) may communicate with the destination device (4) based on the URL associated to the contact destination, using applicable communication channels, e.g., web-based calls, video conferences or web Real Time Communications.

For purposes of this invention, the following terms are defined:

Alphanumeric Name (10)—character(s) involving alphabets only, numbers only, or a mix of alphabets and numbers. It may also include other characters or symbols recognizable by the destination devices. It can also be the domain name or with sub directory name that forms the URL associated with the destination device (4).

Callable Number or number—any contact or telephone number registered with a telephone operator or carrier, either through a subscriber identity module (SIM) card or a public switched telephone network (PSTN) number that can be contacted by mobile devices or fixed phone lines through standard voice, video, messaging media or means. A Callable Number can also be a Session Initiation Protocol (SIP) account, with a user name and password that can be recognized as a device and can receive voice, SIP, or Web Real Time Communication (WebRTC) calls.

Name Generator Server (16)—is a Web Server responsible for creating or provisioning an alphanumeric name appended to a Domain name that produce the callable URL (10) to the callable number of a destination device (4). The name generator server (16) also ensures the uniqueness of the alphanumeric name (10). It allows any destination device user (6) to register the alphanumeric name (10) and callable number to the system and generate a the URL call link that can be opened, and the Real Time Communication can be routed to the proper destination device either via SIM Gateways, GSM Gateways, application servers or SIP terminals and devices.

Call Link (8)—also called URL link or URL callable link which is a generated URL link composed of the domain name appended by alphanumeric name (10) to the domain name and is associated to the callable number of the destination device (4). This link has a syntax to which the alphanumeric name (10) appears either: (1) on the left of the Domain name separated by period “.”, e.g., https//name.domainname, or (2) on the after the main Domain Name preceded by slash “/”, e.g., https://domain name/name or can be the Domain Name itself, e.g. http://Domain name. Alternatively, it can be the domain name, without an appended alphanumeric name (10).

Call Name Server (14)—a Web server that intercepts and receives the call link (8), and responsible for parsing the call link (8) to route calls to the right destination device (4).

Provisioner (2)—is the owner or caller of the Destination device (4), with access to the Internet, that intends to create the alphanumeric name (10) and pair it to the callable number of the destination device (4). The creation of the alphanumeric name (10) is possibly for the purpose of making it easy for the provisioner (2) to contact the destination device (4) through the call link (8), or to share the same link to third parties who may benefit from other modes of communicating with the destination device (4) through a web-browser enabled device.

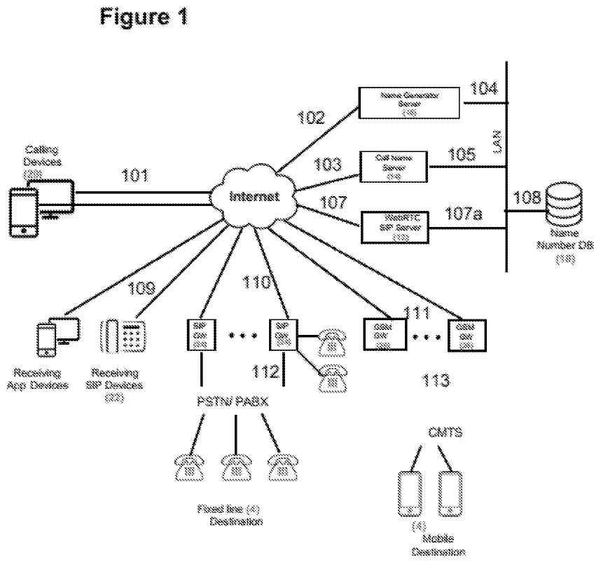

As seen in FIG. 1, the four main components of the system are the following: the Web RTC server (12), Call Name Server (14), Name Generator Server (16) and Name Number Database (18). All these components are interconnected internally using known methods such as a local area network (LAN) or a virtual local area network (VLAN) such that it will work as one system and connected to the Internet.

The WebRTC Server (12) handles multimedia real time communications from the Internet browser of the caller (6) to the GSM or SIP gateway, and eventually terminates to a destination device (4), which can be a mobile phone, telephone or other WebRTC device. WebRTC is an open standard protocol and will be used for the call routing, switching and voice streaming from the Internet browser of the caller (6) to the destination device (4) after a call link (8) is defined and known by the system.

The calling device (20) is any capable WebRTC device that can do multi media real time communications. The calling device (20) only use internal web browsers to communicate with the call name server (14) via WebRTC server (12); the call name server (14) parses and process them so it can route to the destination device (4).

The call name server (14) is a web server that receives the call link (8) from the Internet browser of the calling device (20), and terminates them to the destination devices (4). When a caller (6) opens the call link (8) generated by the name generator server (16) through an Internet browser, the Internet will forward this call link (8) to the call name server (14), and the call name server (14) will parse this call link (8) to determine the destination device (4) based on the defined encoding name to the domain name. The coding scheme can be defined either on the left side of the Domain name in which the alphanumeric name (10) is encoded on the left followed by a Period “.” followed by the Domain name or the right side of the domain name where the alphanumeric name (1) is written after the domain name preceded by a slash “/” as the separator or can be the domain name itself.

The name generator server (16) is a web server that provisions and pairs the alphanumeric name (10) and the destination device's (4) corresponding telephone, mobile number or web account that can be called or contacted via voice, video or messaging, from the browser by using the said call link (8) associated with the alphanumeric name (10). It also determines the type of destination device (4), which can be any mobile communication device; telephone device, SIP account device, SIP App device or gateway device. It makes sure that every alphanumeric name (10) and number registered to the database is unique and not duplicated. To avoid this duplication, it works with the name number database (18) for checking duplication in the database and storing the alphanumeric name (10) and destination device (4), if found to be unique. This server pairs the number of the destination device (4) and the alphanumeric name (10) together and other information to describe the service and stores them for future use by the call name server (14).

The name number database (18) serves as the repository and storage of various information such as customer information, name and number pairing information, system configuration, parameters, destination device (4) types, reports, IP addresses, SIP user accounts and settings. It also provides connection to various servers for information request related to all call related information, provisioning, reports, timing, statistics, and routing.

One of the main functions of the name number database (18) is for call routing purposes. Since it stores and maintains all the IP addresses of all configured destination gateways of the system, it knows which IP address and SIP account a request belongs to either a SIP or GSM gateways. These Gateways described can be off the shelf SIP gateways that support IP conversion to PSTN interfaces such as E1, T1, FXO or FXS ports or GSM SIM based Gateways that supports conversion of IP to mobile networks via mobile SIM interface. In order to have least cost routing capabilities and to group every destination numbers into group of serving gateways, which provides least cost to terminate the call, the IP addresses of every gateway serving a destination device are stored in the name number database (18). With this, multiple SIP or SIM gateways can be maintained by every end caller (6) at their premise to manage their inbound calls with better control of the cost of termination.

The Receiving SIP Devices (22) are SIP terminals capable to connect and register to a SIP server to establish Real Time Communications media from the originating devices using the same SIP or Internet related protocols.

The SIP Gateways (24) are devices that connect to E1, T1, FXO or FXS line from the PSTN side or PBX side, respectively, as marked by line 112 that is between PSTN/PBX Cloud and SIP GW. On the other side, line 110 depicts the Internet protocol link that connects the SIP GW to the DSL, modem, router or similar device that connects to the Internet. It converts VOIP to legacy telephone ports such as E1, T1, FXO or FS lines using RF-45, RJ-11 interfaces, respectively or other similar interfaces.

The GSM Gateways (26) are devices that connect to the CMTS or any 3GPP mobile network through SIM and Internet on the other side. This device allows SIM card to be inserted to the device to have CMTS connectivity shown as wireless line 113. On the other side of the device, it connects to Internet via line 111 that is similar to line 109 and line 110. This line will serve as the gateways for the IP call to be connected to the mobile devices via GSM, 3G, LTE or other similar mobile phone wireless protocols that will do the same wireless connectivity.

Both SIP Gateways (24) and GSM Gateways (26) can be arranged in multi site deployments that are managed by the system.

To make a call, the call link (8) is used to connect to the correct destination device (4), may it be a SIP Phone device or Applications, SIP Gateway port, WebRTC browser user account or Mobile device number connected to another SIP Gateway. The SIP Phone or Application is any device that can make and receive SIP voice, Video or messaging communications, SIP Gateway (24) is any device capable to receive and make Voice call from IP to legacy phones or vice versa, and messaging with either SIM ports or PSTN ports (FXO or FXS). A WebRTC browser user account is any application registered to an SIP Server via WebRTC protocol that can also send and receive, voice, video and messaging. Mobile number of the destination device (10) is a valid number registered with the Telco or mobile operator that can be contacted by the SIP Gateway via SIM port or PSTN port.

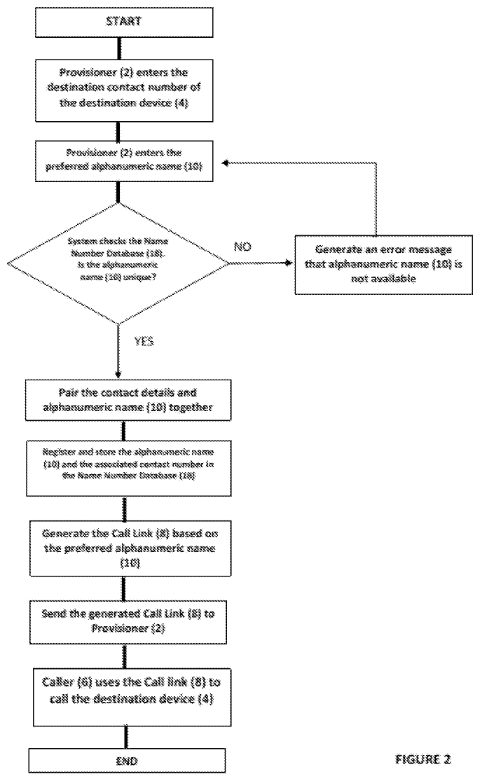

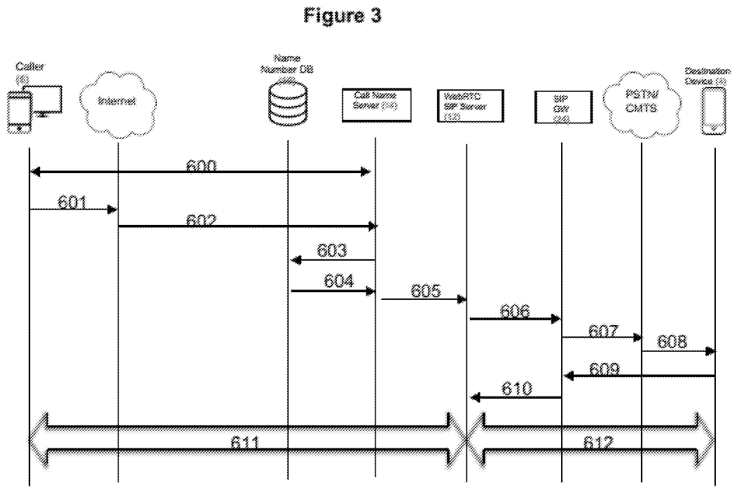

FIGS. 2 and 3 shows how a communication is placed. It is assumed that the caller (6) is using a client Browser app with WebRTC capable device that is connected to the Internet via wireless, DSL, satellite or similar data access network that can connect to the Internet.

The caller (6) opens a WebRTC browser and enters in the URL box the call link (8). Upon entering the call link (8), the packets will be routed to the Internet cloud towards the call name server (14).

a. Call link (8) (Mandatory)
b. Address of the Owner of the Name (Optional)
c. Company Name of the Owner (Optional)
d. Picture or Animated pictures of the Name Link (Optional)
e. Input Box for Caller's Name (Mandatory)
f. An SMS Entry Box for sending Message
g. Call Button to call the paired number of the Name (Mandatory)
h. Send Button to send message to the paired number of the name
i. Call and Message Status display

After the caller (6) enters the call link (8), the information will be sent to the call name server (14). After the call name server (14) receives the inputs from the caller (6), it will then parse the entered URL link to extract the alphanumeric name (10). The alphanumeric name (10) can be in the beginning of the domain name or at the end of the domain name.

After decoding the alphanumeric name (10), it will inquire the alphanumeric name (10) appended to the call link (8) about the routing information from the name number database (18). The alphanumeric name (10) is a unique identifier in the name number database (18) that can search call routing information related to how this name was provision, the type of device and how to terminate the call. The name number database (18) will search the name number database (18) and will then reply the information related to this name number database (18), information such as but not limited to the Mobile number, Account number, SIP Gateway Public address, SIP Device or application account, Port used for the SIP and RTP stream, and username (604). All these information can be present all at once or selected portion or parts only depending on the type of destination device and how it was provisioned during its creation. After the call name server (14) determines these information, it will then forward all these information to the WebRTC server (12) so proper routing and call processing can be handled properly. With all these information at the WebRTC server (12), it then makes a call request to the destination device using either SIP or WebRTC protocol and using the information such as, IP address, user account or mobile number of the destination device (4) previously supplied by the name number database (18) using existing technology.

The domain name appended with the alphanumeric name (10) created by the name generator server (16) can be deciphered by a name call server (28), and such name call server (28) can take the necessary action to identify and route the particular alphanumeric name (10) from the web-enabled browser, and establish a call to the destination end device

As seen in FIG. 2, this invention teaches a method of creating a call link (8) by pairing an alphanumeric name (10) with a destination device (4).

The provisioner (2) will enter the URL of the name generator server (16) in an Internet browser, after which a webpage will be displayed. The provisioner (2) will enter in the webpage the phone number of the destination device (4) and the desired alphanumeric name (10) to be associated with such destination device (4).

The name generator server (16) will then confirm with the name number database (18) if the alphanumeric name (10) is unique and thus available. If the alphanumeric name (10) is available, the name number database (18) will create a call link (8) associated to this request and then send confirmation to the name generator server (16).

The call link (8) may have the following syntax:

Ex: Name Link at the end of the Domain—https://Domain name/name link.
Ex: Name Link in the beginning of the Domain—https://Namelink.Domain name
Ex. Name link is the Domain Name itself—https://Domain Name.
For Example, if the Name selected is John and the mobile number paired is yyy-yyyy, in which the value of “y” can be any combination or length that are real mobile or fixed line numbers or any callable numbers and the Domain Name is the domain name of the Call Name Server e.g. hashcall.me, then the unique name link to be created for this request will be;
https://hashcall.me/john or https://john.hashcall.me

The call name server (14) can understand both when this request arrives to it via Internet.

This call link (8) will now be used by the call name server (14) to decode and switch the call or message request from the calling device (20) to the destination device (4).

In another embodiment of the method, the name call server (28) may optionally be required to notify the Destination Device (4) of the association of an alphanumeric name (10) and its registration in the name number database (18).

For clarity, the destination device (4) is an SIP phone wherein instead of the call number, the e-mail address of the SIP Phone will be entered by the provisioner (2) in order to register the alphanumeric name (10). During registration, the provisioner (2) may be allowed to receive information necessary to connect to the SIP phone, such as SIP Server IP address, SIP Ports to be used, etc. Thus, throughout the description, when the destination device (4) is an SIP Phone, the number of the destination device will refer to an e-mail address.

A single or multiple SIP phones may be the destination device (4).

In another embodiment of this method, the user of the destination device (4) is the one that creates the alphanumeric name (10). The call name server (14) may optionally send a code to the destination device (4), and the user of the destination device (4) must timely input this code on the name generator webpage.

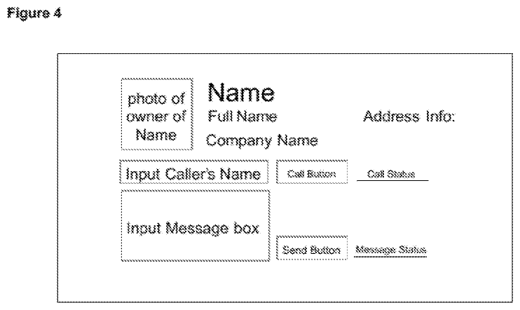

FIG. 4 shows an example on how a name call server (28) displays the web page when the caller (6) in the Internet browser enters the call link (8). When caller (6) enters the call link (8), a web page described in this FIG. 4 will be displayed. Some of these information are non-mandatory and will be left to the discretion of the Provisioner (2) on how he will provision the profile. It is preferred though that username of the caller be entered (6), with custom image, custom video and other information being optional. This will allow the system to provide information to the destination party on who is the caller for verification purposes since calling via WebRTC does not require calling party's number. In the future, calling party account can be incorporated to identify and authenticates the caller. For sending message, the message box must be filled out also with alphanumeric characters with flexible length of the number of characters and must press the Send button to send the message to the destination device (4) using existing technology.

1. A system for automatically pairing a unique and assignable alphanumeric name to any IP enabled mobile devices (4) comprising:
a name generator server (16), name number database (18), call name server (14), and destination device (4) that are all interconnected through a network;
the provisioner (2) of a destination device (4) selects a custom alphanumeric name (10) and enters it via Web Portal of the name generator server (16);
a call name server (14) will validate with the name number database (18) if the selected alphanumeric name (10) is existing in a name number database (18).
if the alphanumeric name (10) is unique, the name generator server (16) will reply to enter the number of the destination device (4) and the alphanumeric name (10).
a confirmation message will indicate successful pairing of the alphanumeric name (10) and the number of the destination device (4) and will show a call link (8).

2. The system as claimed in claim 1, comprising:
the name generator server (16) to append the alphanumeric name (10) to an assigned domain name either in the beginning, at the end of the domain name or just the domain name itself, pair them and store these information to the name number database (18).

3. The system as claimed in claim 1 comprising:
allowing the provisioner (2) to add custom image and custom video during the pairing that can be integrated to a user interface page so that the caller (6) can add additional information to identify the destination device's (4) profile. That this information will be saved as an additional information to the name generator server (16) of the profile of the destination device (4).

4. A method for pairing an alphanumeric name (10) with a destination device (4) callable number comprising:
accessing the name generator server (16) by the provisioner (2);
inputting the callable number of the destination device (4) by the provisioner (2);
inputting the desired alphanumeric name (10) by the provisioner (2);
verifying the availability of the alphanumeric name (10) with the name number database (18) by the name generator server (16);
associating the callable number of the destination device (4) with the alphanumeric name (10) by the name number database (18); and
generating the call links (8) based on the assigned domain name and the alphanumeric name by the name number database (18).

5. The method as claimed in claim 2, comprising:
notifying the destination device (4) by the call name server (14) that an alphanumeric name (10) has been associated with it in the name number database (18).

6. The method as claimed in claim 4, comprising:
allowing a caller (6) to enter the name identity of a caller (6) to the portal before the call name server (14) connects the calling device (20) to the destination device (4) to identify the caller (6) in the system and sending this information to the destination device (4) either through number translation or any other means to identify the caller (6) based from the data entered for the name of the caller (6).

7. The system as claimed in claim 3 further comprising:
the call page can display and insert custom video or image associated with the destination device (4) to further advertise specific information for the caller (6) to identify the identity of the destination device (4) prior to proceeding to dial the destination device (4).

8. The system as claimed in claim 1 comprising:
the name generator server (16) also accepts inputs from other connected applications coupled via any standard data connection or API that can also send and pass the same information such as alphanumeric name (10) and other information that needs to be paired and stored in the system as additional provisioning command from third party devices or systems, along for the generation of unique call link (8) for the third party applications.

9. The system as claimed in claim 1, comprising:
the call name server (14) is a web server with a registered domain name address and public IP address or addresses that can be accessed by the calling device (20) from any Internet connection and having similar main domain name address as the name generator server (16).

10. The system as claimed in claim 3, comprising:
the name generator server (16) to allow provisioner (2) to activate or deactivate the user interface display so that the caller (6), after entering the call link (8), have a direct call function to the destination device (4) through the Video and/or image in the user interface page before connecting to the destination device (4).

11. The system as claimed in claim 2 comprising:
allowing the provisioner (2) to add custom image and custom video during the pairing that can be integrated to a user interface page so that the caller (6) can add additional information to identify the destination device's (4) profile. That this information will be saved as an additional information to the name generator server (16) of the profile of the destination device (4).
